(19) United States
(12) Patent Application Publication
(10) Pub. No.: US 2005/0072372 A1
(43) Pub. Date: Apr. 7, 2005

(54) Hair removal and animal husbandry method

(76) Inventors: Philip Ian Hynd, South Australia (AU); Natasha Marie Penno, South Australia (AU)

Correspondence Address: R Neil Sudol Henry D Coleman;William J Sapone, Coleman Sudol Sapone, 708 Third Avenue 14th Floor, New York, NY, 10017-4104, US

(21) Appl. No.: 10/500,835

(22) PCT Filed: Jan. 8, 2003
(86) PCT No.: PCT/AU03/00009

(30) Foreign Application Priority Data
Jan. 9, 2002 (AU) PR 9882

(51) Int. Cl. A01K 29/00

(52) U.S. Cl. 119/651

(57) ABSTRACT

Long term removal of hair is achieved by delivering a collagen cleaving agent intradermally or subdermally. This is thought to disrupt the fine collagen network anchoring the hair follicles within the dermis and additionally by altering the normal functioning of the dermal papilla cells located in the base of the hair follicle. The method of removal is applicable to animal husbandry methods such as maintaining the breech of sheep hairless and thus has application as a substitute to mulesing. The method is also applicable for cosmetic hair removal.

This invention relates to a method for the removal of hair from a mammal, and in one specific aspect for animal husbandry purposes.

### BACKGROUND OF THE INVENTION

The removal of hair from certain regions of the body of some animals is considered an important animal husbandry activity. Sheep raised for wool, such as merinos, have been bred to enhance wool production, and thus the more wool borne by the sheep the greater the economic return. Part of the breeding process has involved enhancing loose skin characteristics to increase the number of hair follicles and thus yield of wool. A side effect of not only the loose skin but also the greater production of wool is that the breech of a sheep where it is not appropriately maintained is readily subjected to urine staining, fecal soiling or dags. Excessive moisture in the skin folds also results in bacterial growth and an odour that is an attractant for the gravid blowfly female to lay eggs, resulting in an enhanced fly strike rate. Breech strike, as it is known is the primary form of blowfly strike accounting for more than 80% of all blowfly strikes.

While crutching of sheep at appropriate times of the year reduces the incidence of breech strike, a significant number of sheep still become struck in this region. An operation pioneered by J H W Mules was introduced in Australia in the 1930's to remove folds of skin in the breech and to reduce the amount of wool on the breech, hence the amount of faecal and urinary soiling of the region. The Mules operation has been widely adopted by Merino sheep producers. Approximately 20 million lambs are mulesed in Australia each year.

The original operation involved pinching a fold of skin on either side of the perineal area with Burdizzo pincers and cutting the fold off with a knife. This operation was considered, at the time, not to be painful because of the pressure of the pincers. Later the Mules operation was extended to remove skin from the tail, this was referred to as the ‘Modified Mules operation.’ The pincers and knife were replaced with blade shears to perform the operation. In Western Australia the mulesing contracting industry extended the area of skin removal in the crutch area as well as performing a total strip of the tail skin—the so called “Radical Mules Operation.”

Apart from animal welfare concerns the Radical Mules Operation results in secondary problems such as a large wound area, increasing the chances of infection, secondary joint infections, wound contraction and distortion of tail and vulva. The longer-term problem of an increase in UV light induced skin cancer of the perineal region also became evident.

An alternative to the Mules operation is considered a high priority by the Merino sheep industry due to mounting consumer and animal activist pressure to improve animal welfare, but at present no such alternative exists.

Removal of hair is also important in other fields of endeavour, notably in the cosmetic industry, where a very wide range of methods have been tried. A major hurdle is finding a method that is cosmetically acceptable but at the same time long lasting, and easy to use.

Known methods for cosmetic removing body hair fall into two main categories, namely physical and chemical. Physical methods for removing hair typically rely on pulling the hair fibre away from the follicle, cutting the hair off at the skin surface, or pulling the entire hair follicle out of the follicle canal. It is only the latter method that results in permanent removal of hair.

Common physical methods for hair removal include the use of tweezers to physically remove the hair fibre and/or the follicle, the use of razors or the like to sever the hair fibre at the skin surface. Another common method is so called “waxing” whereby heated wax is applied to the area from which the hair is to be removed, allowing the wax to engulf individual hair fibres and then allowing the wax to cool and harden slightly, at which point the wax is removed, thus physically tearing the encapsulated fibre away from the follicle. Waxing typically does not remove the entire hair follicle and therefore the hair eventually grows back. Another method similar to waxing is known as “sugaring”. Sugaring involves layering a warm sugar paste over the affected skin covering with a cotton cloth, allowing the paste to set and tearing this away from the skin together with enveloped hair fibres.

Methods for permanently removing hair are known, and some require individual hair follicles to be burned with a laser, thereby rendering them ineffective in regenerating hair fibres. Methods such as those described are typically very painful and often result in a localised inflammation of the dermis adjacent the follicle canal (erythema). The laser method requires repeated treatment to permanently destroy hair follicles and evidence that the hair removal is permanent is equivocal. Techniques such as physical removal of individual hairs also tend to be expensive because of the amount of time required to treat a particular area.

It is believed that in order for hair to regrow it is necessary only to have the combination of a dermal and an epidermal cell within the follicle canal. Therefore if a single epidermal or dermal cell is viable and comes into contact with a dermal or epidermal cell respectively, then hair regrowth will occur. Thus permanent removal of hair requires the destruction or removal of all epidermal cells present in the canal.

Chemical hair removal methods in the past have typically involved the use of thiol reducing agents to break down keratin of the hair fibre into ‘soft’ keratin that is more readily removed from the hair follicle. As a result these techniques usually do not result in the removal of the hair follicle and therefore regrowth of the hair fibre occurs. Examples of such treatments can be found in U.S. Pat. No. 4,152,784 to McGalliard and U.S. Pat. No. 4,121,904 to Schamper.

Secondary agents for treating the hair follicle to inhibit its ability to regenerate hair fibre have also been used. These agents are applied to the skin after the hair fibre has been removed from the follicle by mechanical or chemical means. Thus the hair follicle is exposed by removal of the hair fibre and is treated with the agent. Known agents include photosensitisers and light, toxins or electric current (see for example U.S. Pat. No. 5,669,916 to Anderson).

U.S. Pat. No. 3,794,028 to Mueller et. al. addresses the problem of chemically removing the entire hair follicle to prevent regrowth by micro-injecting a depilatory solution into the hair follicle to permanently destroy hair growth at that location. In particular the method requires a sodium hydroxide solution to be injected into individual hair follicles. Thus the method uses a harsh solution and is time consuming because of the need to treat each individual hair follicle.

There is therefore a need for a relatively inexpensive and easy method to remove the entire follicle, whilst resulting in minimal damage to the surrounding dermis.

### SUMMARY OF THE INVENTION

The present invention has resulted in a simple approach to the long term removal of hair. This has been shown to be easily applied in an animal husbandry setting. The method involves delivering a collagen cleaving agent beneath the surface of the skin of a live mammal in a form that provides a depilation effect.

In particular this invention differs from all depilatory methods for use on live mammals known to the inventor in that this is the only method known to utilise the depilatory and perhaps also hair growth inhibitory properties of a collagen cleaving agent.

In a first aspect the invention might be said to reside in a method of removing hair from a live mammal, including the steps of delivering a collagen cleaving agent beneath the surface of an area of skin, allowing time for the collagen cleaving agent to cleave collagen, and removing hair present in the area of skin.

In a second aspect the invention might be said to reside in an animal husbandry method including the steps of delivering a metalloproteinase beneath the surface of an area of skin in an amount effective to depilate the area of skin.

For a better understanding the invention will be described with reference to a number of examples.

### BRIEF DESCRIPTION OF THE DRAWINGS.

FIG. 1 shows the inhibitory effect of collagenase on fibre growth in vitro. Concentrations of collagenase greater than 0.001% inhibited fibre growth in vitro.

FIG. 2 is a schematic drawing of a hair and its follicle showing the connective tissue (1); the hair fibre (2); the inner root sheath (3); the outer root sheath (4); the bulb (5) and the dermal papilla (6),

FIG. 3 shows photomicrographs of (a) follicles plucked from a collagenase treated skin site showing the fibre (2), the bulb (5) and the inner (3) and outer (4) root sheaths; and (b) fibres plucked from a control site not treated with collagenase,

FIG. 4 shows photomicrographs of skin sections (a) from a control site not treated with collagenase showing the follicle canal (7) from which the fibre (2) has been removed but the bulb and dermal papilla remain halfway (8) up the follicle canal towards the skin surface (9); and (b) from a collagenase treated site showing empty follicle canals (7),

FIG. 5 is a histogram setting out the effectiveness of five different enzymes on depilation. The scale on the Y axis refers to the proportion of intact follicle bulb ends after plucking of skin treated with different enzymes (relative to the control=1). For example a value of 3 means there were 3 times more intact bulb ends following collagenase treatment than were apparent for the control skin

FIG. 6 a) is a photographic view of a healed breech of an adult sheep that has been subjected to the mulesing procedure, b) is a photographic view of the breech of a lamb 6 weeks after having been subjected to collagenase treatment at two sites.

### DETAILED DESCRIPTION OF THE INVENTION

Experimentally it has been found that by an injection of 0.1 ml of an aqueous solution of collagenase at a concentration in the order of 0.01% (w/v) or greater when introduced into the dermis in the crutch of a sheep has the effect of depilating an area estimated to be about 5 cm². The collagenase spreads through the dermis from the point of injection, and is believed to disrupt the collagen network which is thought to be essential for hair follicle attachment in the skin, and also for normal hair growth processes. A serous scab forms at the depilation site and on falling off, the hair and hair follicles are taken with the serous scab leaving a depilated area. In trials to date the depilation has been effective for a period of about 4 months, up until slaughter, with no sign of regrowth. It is anticipated that such a depilation procedure might not need to be repeated throughout the life of the sheep, or other mammal to be treated, however it might be necessary to repeat the procedure periodically. This might to some extent be dependant on the concentration of collagenase or other enzyme.

The efficacy with which the exemplified procedure has worked, with minimal damage to surrounding tissue together with the long term nature of the hair removal effect is unexpected.

It is thought that the action of collagenase or other matrix metalloproteinases on hair growth is two-fold: the first is that a fine collagen network anchors the follicle within the dermis so disruption of this anchoring network results in liberation of the entire follicle from the skin. The second is that collagen matrix is involved in the normal functioning of the dermal papilla cells located in the base of the hair follicle. Disruption of the matrix will alter normal fibre-producing processes in the follicle bulb, so that fibre growth is inhibited, possibly permanently.

Experiments to date have shown that a number of the family of matrix metalloproteinases are capable of cleaving collagen and therefore having the effect. These include MMP-3 (also known as stromelysin), but the preferred collagen-cleaving agent is crude collagenase, comprising a mixture of collagenases because these are cost effective. It will be understood that there are a large number of collagenases and matrix metalloproteinases available and that the invention is not restricted to any one particular collagenase or matrix metalloproteinase and therefore it is contemplated that most if not all of the available collagenases and matrix metalloproteinases can be used in the practice of the invention. The primary limitation on the selection of collagen cleaving agent is that it is able to weaken the adhesion that the connective tissue provides between the follicle and the surrounding dermis within a time period in which damage to the surrounding dermis is minimised. In a particularly preferred form of the invention the collagen cleaving enzyme is a mixture of at least two collagenases selected from the list of bacterial collagenases including Type IV, Type II, Type XI, Type I, Type VIII and Type V. These enzymes may be from Clostridium histolyticum and may be available commercially. The mixture of collagenases may also contain other proteases. It will be understood that the collagenases or matrix metalloproteinases may be altered proteins such as truncation, mutant or deletions.

In the case of collagenases or other matrix metalloproteinases, the enzyme(s) may also be used in conjunction with a source of divalent cations such as Zn²⁺ or Ca²⁺.

The collagen cleaving enzyme may be a protease, or a truncation, mutant or deletion thereof. However, there are a large number of available proteases and it is possible that there may be some proteases that are able to weaken the adhesion the connective tissue provides between the follicle and the surrounding dermis within a time period in which damage to the surrounding dermis and to the hair fibre or follicle is minimised.

Experiments to date suggest that levels of enzyme(s) in the composition, at least for the crude collagenase preparation, may need to be greater than about 0.01% w/w. It is known that 0.001% appears not to be effective however with suitable delivery methods or using enzymes with higher specific activities such levels may still be effective. Empirical trials will readily determine an appropriate level of enzyme to be added for effective removal of hair. Similarly with such trials it will be readily determinable whether unacceptable damage is occasioned to surrounding tissue. In that regard with sheep trials conducted to date, whilst some minor scarring has occurred the level of damage to the skin has been minimal. The treatment has led only to a transient eschar, with no particular evidence of discomfort to lambs.

To date the means by which the collagen-cleaving enzyme has been introduced in sheep is via injection by syringe. The needle in the above case is inserted into the dermis delivering a volume of about 0.1 ml. It will be understood that the volume delivered and the method of delivery can be varied. The introduction of a volume of enzyme solution as effected in present trials, forces the collagen cleavage enzyme to spread throughout the dermis, and thus the pressure of the volume that is introduced should assist with spreading the enzyme and therefore the depilatory effect. Where only a minimal volume of some microlitres is delivered without the application of pressure the interstitial fluids within the dermis might be expected to carry the enzyme from the site of introduction but perhaps not distributing the enzyme to the same degree.

The site of delivery is preferably the dermis however it is anticipated that a subcutaneous delivery may well also be effective, providing enough contact with collagen network associated with the hair follicle of the area desired to be treated. It will be understood that the method of delivery may be by breaching the skin (for example, by injection or high pressure aerosol) or by application of a cream or other dermatological carrier with properties allowing delivery of the enzyme through the protective layers of the skin, or perhaps by electrical co-migration techniques such as iontophoresis.

It will be understood that this method is ideally suited as a means of depilation in the breech of a sheep as a replacement of the present practice of mulesing sheep. It is anticipated that this method will have permanent effects over the life of a sheep, however, the method will still be useful should the process be required to be repeated periodically.

The invention has given a long lasting depilation effect with minimal surface damage and is therefore anticipated to be applicable beyond animal husbandry methods and specifically to hair removal on, for example, humans for cosmetic purposes.

In particular for cosmetic purposes it is desirable that delivery is other than via injection. There may be a number of delivery methods and it is possible that delivery of the enzymes to their site of action may be by diffusion and thus might be achieved by simply applying the enzyme to the surface of the skin. However, it is preferred that the method includes the use of penetration enhancing means for assisting delivery of the enzyme(s) to their site of action. A number of means for achieving penetration enhancement might be used and these, include the employment of ultrasound, heat, pressure waves, iontophoresis or surfactants. Thus in one form of the invention the area treated may be heated in order to soften the skin and assist penetration of the enzyme(s) into the follicle. The heat source may for example be an infrared lamp. The heat may be applied prior and/or during application of the enzyme(s). Chemical penetration enhancers are also known and these might be used to assist penetration of the enzymes into the skin and around the hair follicle. Thus the enzymes may be used in a carrier which provides a low surface tension between the carrier and the skin so as to promote diffusion into the skin. Enhanced enzyme penetration could also be achieved using a combination of heat and chemical means.

The enzyme(s) may be applied topically in a composition comprising the enzyme(s) and a suitable non-toxic dermatologically acceptable carrier. Suitable carriers include water, ethanol, water/ethanol mixtures, oils such as paraffin oil, petroleum oil, mineral oil, silicone oil, fatty alcohols, glycerin, and soft white paraffin. The composition may be in any suitable form including as a solution, gel, lotion, cream, aerosol, water in oil or oil in water emulsion. In one preferred form the carrier is soft white paraffin. In another preferred from the carrier is water based.

The composition may also include one or more additives such as penetration enhancers, dyes, fragrances, colourings, preservatives, fillers, gelling agents or thickeners, antiseptics, anaesthetics, emulsifiers, emollients, stabilisers. Suitable fillers could include chalk, talc, magnesium oxide, magnesium carbonate, clays, titanium oxide, fumed silica, or mixtures thereof. Suitable emulsifiers could include anionic surfactants. Suitable gelling agents could include tragacanth, xanthan, karaya and guar gums, clays, methyl or hydroxyethyl cellulose, hydroxypropyl cellulose, carboxymethyl cellulose, fatty and polyvinyl alcohols, modified starches and sugars.

Levels of enzyme(s) in the composition for cosmetic purposes for topical application may be between 0.05% and 30% w/w. In a preferred form using a crude collagenase preparation the levels of enzymes is between 0.1% and 10% w/w, and in one particularly preferred form the levels may be between 0.5% and 3%. The level of enzymes used may be determined in part by the type and the activity of the enzyme(s). It is preferable of course that the levels of enzyme are not so high as to cause substantial damage to the surrounding dermis, yet not so low as to require extended periods of time in contact with the skin and hair. In particular the levels of activity of enzyme(s) may be between 400 and 1860 units per milligram.

It will be understood that for cosmetic purposes it is important that the surrounding dermis remains substantially unaffected by the treatment so that it does not result in excessive burns, swelling, or blemishes of the skin. Generally with existing treatments there is a transient visual impact such as reddening or tenderness of the skin following treatment, and that level of trauma may be acceptable to the user, however it is preferred that the trauma occasioned is less. Experiments conducted to date suggest that the reason for the lack of permanent damage other than to the hair follicle is the result of the difference in thickness between the connective tissue capsule surrounding the follicle and the surrounding dermis so that the time taken to act on the relevant collagen fibres is not sufficient for the enzyme to have a significant or at least long term damaging effect on the surrounding dermal tissue.

The efficacy of the method also depends on the type of hair and therefore varies from person to person. Thus one person may have hair follicles that are particularly difficult to remove and therefore the enzyme(s) may need to be in contact with the skin for a longer period of time than it would for a person with hair follicles that are more readily removed. It is understood that cosmeticians and others that deal with hair removal are able to readily assess the relative ease of hair removal in individuals and therefore it is within the realms of their standard knowledge to make a preliminary assessment as to the length of time the enzymes may need to be in contact with the skin.

The preferred length of time by which the one or more enzymes is contacted with the skin may also depend in part on the type, activity and concentration of the enzyme(s) used. Experiments conducted to date indicate that a composition containing approximately 1% (w/w) of enzymes can be contacted with the skin for about 30 mins to allow for complete removal of the follicle, without causing substantial damage to the surrounding dermis. It will be understood that other concentrations and times may be used and therefore it may be possible to use a composition containing 10% enzymes for 5 minutes contact with the skin. It will also be understood that the concentration and time required to effect removal is also dependent on the hair type of the subject and therefore, for a given concentration of enzyme, the time required will vary from person to person.

It might be desired to stop the action of the collagen cleavage enzyme after a certain time. Thus for example after the application of the enzyme a collagen cream might be applied. The collagen cream might include a penetration enhancer as well. One or more applications of collagen cream might be desired over a predetermined time period following treatment.

The method may also include application of one or more wound healing agents that may assist in healing any wounds resulting from the treatment. These may be applied after the time required for treatment by the collagen cleaving enzyme. Suitable wound healing agents may include aloe vera, essential oils, antibiotics, hydrocortisone, vitamin K, colloidal silver, retinol, zinc and EGF.

Generally with hair removal treatments it is recommended that a “hair inhibitor” is applied after hair removal, and the invention might encompass using such an inhibitor after treatment.

The composition may also be microencapsulated in the form of pressure sensitive microcapsules containing the composition. Reference may be made to U.S. Pat. No. 4,152,784 to McGalliard for techniques for microencapsulation. The microcapsules may be dispersed on adhesive plasters so that application of an adhesive plaster to the area of skin containing unwanted hair causes the microcapsules to burst and thereby deliver the composition to the skin. It may also be possible that hair fibres may become adhered to the plaster so that removal of the plaster after a period of time causes hair follicles to be removed therewith.

### EXAMPLE 1

### Cultured Follicle Growth is Inhibited by Collagenase

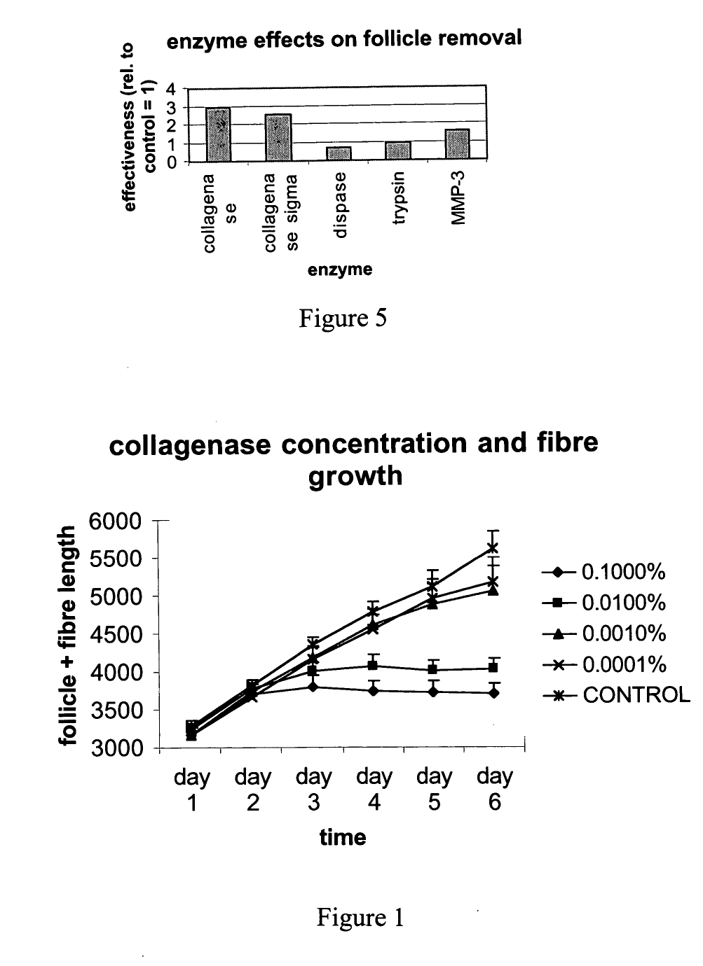

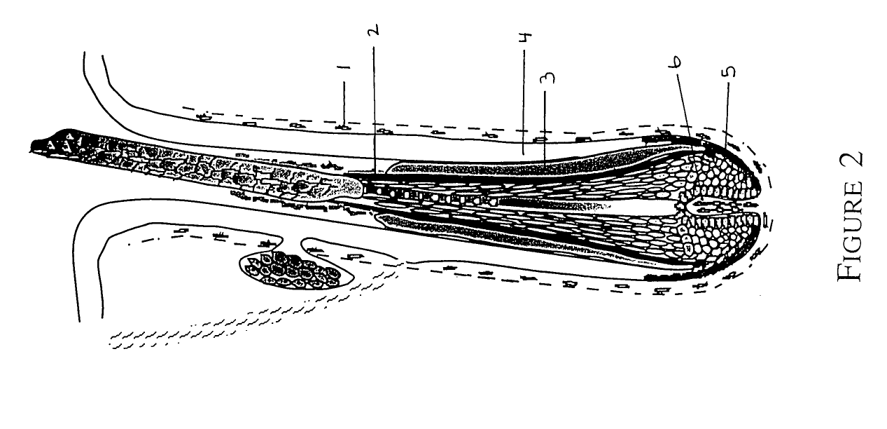

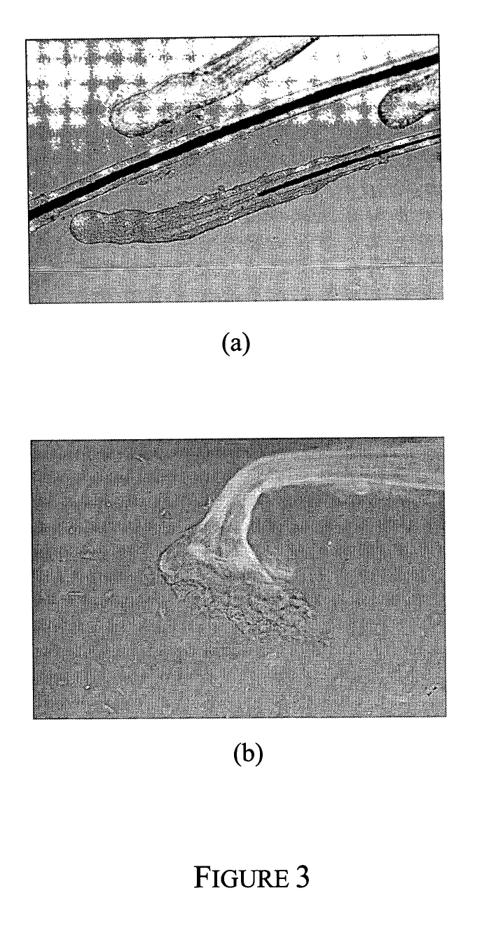

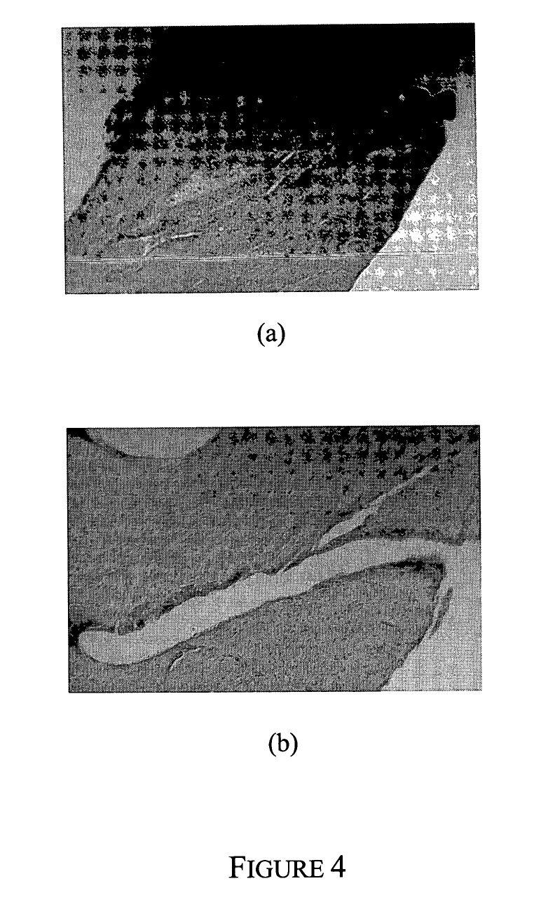

A thin strip of skin was removed from an anaesthetised area of the midside of a sheep. The skin strip was immediately placed in culture media (Williams E-Sigma Chemical Co.) and taken to the laboratory. Follicles were microdissected from the skin and placed in individual wells in a 24-well plate. Williams E Media was added to each well. Varying concentrations of collagenase were added to each well (0.1%, 0.01%, 0.001% and 0.0001% and 0% collagenase (Sigma crude collagenase Type 1A Sigma product no. C9891). Fibre growth was measured daily for 6 days. Detailed description of the in vitro culture method is presented in (Bates, Hynd, Penno and Nancarrow 1997-British J. Dermatology 137: 498-505. See FIG. 1 for results.

### EXAMPLE 2

### Treatment of Pig Skin

Methods

A dead piglet was obtained and the skin surface was cleaned using 70% ethanol. A collagenase mixture (1% w/w of Type IV, Type II, Type XI and Type V collagenases (Sigma Pharmaceutical, Australia)) in soft, white paraffin (Prosana Laboratories, Queensland, Australia) was painted onto one midside of the dead pig and the painted area of skin was heated using an infrared lamp at a distance of about 25 cm from the skin surface for 30 mins. After this time the pig was rotated and the opposing midside was painted with soft, white paraffin containing no collagenase. This skin surface was also heated for 30 mins using the infrared lamp as before. After cooling for approximately 10 mins the paraffin and paraffin/collagenase mixtures were scraped from the skin surface.

Fibres were then plucked from each side using forceps and mounted onto microscope slides with DePeX for microscopy. Both treated areas of skin were then waxed using a commercially available home wax treatment (Nair Easiwax® strips). Biopsies of skin were collected from these hairless skin sites and fixed, processed and sectioned for histology. The skin sections were stained with SACPIC staining.

Results

Gross Observations

Fibres plucked from the collagenase/paraffin treated site came away from the skin very easily compared with the paraffin treated site where more force had to be applied and fibre tearing could be felt.

Microscopy of Fibres

Fibres Plucked From Paraffin Treated Control Site:

No fibres were observed with any outer root sheath (ORS) attached to them. Some of the fibres had rounded, hollow ends with a gap left where the dermal papilla and remaining bulb cells would normally sit. The remaining fibres had torn, brush like ends where the fibre had broken at the keratogenous zone. The occasional fibre had wavy, stringy fragments of tissue attached to the fibre shaft that are thought to be sections of inner root sheath (IRS) and a pointy fragment of tissue at the bulb end that could be dermal papilla but there was still no ORS present.

Fibres Plucked from Collagenase Treated Site:

100% of the fibres plucked out and mounted had been removed from the skin in their entirety. All of the fibres clearly had a visible dermal papilla and an entire ORS encapsulating the follicle. Some of the follicles had been pulled out in clumps and epidermal tissue was still attached to them.

Microscopy of Skin Sections

Skin From Paraffin Treated Site:

Some fibres that have clearly been pulled on by the waxing treatment show that the fibre has been removed but that the bulb end and dermal papilla have been left halfway up the follicle canal towards the skin surface. The fibre has broken at the keratogenous zone. Other follicle canals appear to be empty except for a group of cells at the very bottom that are highly vacuolated in appearance and have not yet been identified. In these cases the ORS was missing as well. The rest of the follicles have remained completely intact in the skin with the fibre broken off at the epidermis and have only a slightly altered appearance due to the pulling force applied to them during waxing.

Skin From Collagenase/Paraffin Treated Site:

Empty follicle canals were seen in the tissue with no remaining intact follicles present. These canals also have large vacuolated cells at the bottom of the canals. The dermal sheath appears to be still present in the tissue but all traces of the follicle (fibre, IRS, ORS dermal papilla, bulb) are missing.

Conclusion

The control tissue treated only with paraffin and heat still has evidence of cells of the dermal papilla and ORS and bulb left in situ and these cells have the potential to form a new hair fibre. All of the above results and observations suggest that the entire follicles have been removed from the skin when it has been subjected to collagenase/paraffin and heat. There are no traces of the cells thought to have the potential to produce a new follicle and hair fibre.

### EXAMPLE 3

### Testing of Different Enzymes

The crutch of live sheep were tested for the effectiveness of a range of enzymes to assess the likely range of enzymes that might have an effect.

The following enzyme solutions were prepared: 0.1% collagenase (crude collagenase Type 1A Sigma Product no. C9891 made in saline with CaCl₂ 0.13 g/l, collagenase sigma blend Type F (Sigma Product no. C7926) made in saline with CaCl₂ 0.13 g/l, 0.1% dispase I (Roche Diagnostics Australia Product no. 210455 made in saline with no CaCl₂, 0.5% trypsin/EDTA Gibco BRL Product no. 15405-012 made in saline with no CaCl₂, 0.1% MMP3 (stromelysin, transin, proteoglycanase) Sigma Product no. M1677 made in saline with CaCl₂ 0.13 g/l. For each enzyme 1 ml was injected dermally. Approximately 2 hours later, the wool fibres on injected sites were plucked manually using forceps. Plucked fibres were placed on microscope slides with paraffin oil and the number of intact follicles versus broken follicle ends counted.

A repeat of this plucking experiment was done in vitro to allow greater control over enzyme application. The results confirmed those obtained in vivo, that is, collagenase allowed entire, intact follicles to be plucked from the skin after collagenase treatment. Trypsin and dispase were ineffective relative to collagenase while MMP3 was intermediate in effect (FIG. 5).

We conclude that the most effective enzyme group for depilation is the matrix metalloproteinases and most particularly the collagenases.

In vitro

A range of concentration of collagenases (0%, 0.1%, 0.01%, 0.001% and 0.0001%) were used as for in vivo testing of hair fibre growth in harvested hair follicles. Concentrations of collagenase greater than 0.001% inhibited fibre growth in cultured follicles.

### EXAMPLE 4

### Alternative to Mulesing of Sheep—First Trial

A trial using 12 lambs was conducted to determine the effectiveness of treating the breech of lambs to remove wool as an alternative to the presently widespread practice of mulesing. 0.1 ml of a 0.1% aqueous preparation of collagenase was injected about 1 mm beneath the surface of the skin at 6 different sites around the breech.

It was found that simple hand application worked effectively causing minimal discomfort to the lambs.

Six weeks later the injected sites were examined and found to contain evidence of thin scar formation followed by sloughing of the scab rendering the area of skin hairless. The hairless skin appears to be healthy, pink and soft with a slight scar ridge under the surface.

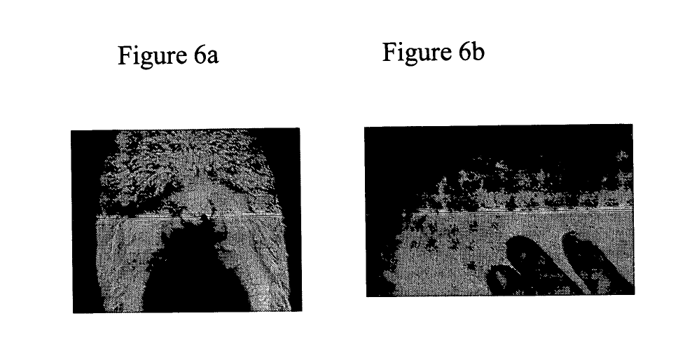

FIG. 6a shows a healed mulesed area on an adult sheep. FIG. 6b shows collagenase treated areas on the breech of a lamb 6 weeks following treatment.

On inspection about 4 months after injection the site remained hairless.

### EXAMPLE 5

### Alternative to Mulesing of Sheep Second Trial

8 sheep were treated with a solution of collagenase (0.5% collagenase (Sigma Product no. C7926) in phosphate buffered saline with Calcium (0.13 g CaCl₂/l). 0.1 ml of collagenase solution was injected into 4 sites on either side of the tail and 2 sites on top of the tail. It is anticipated that perhaps less injection sites may be required.

Inspection of these sheep at weaning (12 weeks of age and approx. 6 weeks after treatment) revealed no detrimental effects of the treatment.

It will be understood that this invention is applicable to a range of procedures for hair removal in animals and is not limited to solely being an alternative to mulesing. It might be used for example as an alternative to pizzledropping in male sheep. Removal of hair from animals other than sheep is also contemplated by this invention. Examples include, tattooing of skin in dogs, horses, cats and other domestic animals, and removal of hair from pigskin prior to slaughter.

1. A method of removing hair from a live mammal, including the steps of delivering a collagen cleaving agent beneath the surface of an area of skin, allowing time for the collagen cleaving agent to cleave collagen, and removing hair present in the area of skin.

2. The method of removing hair as in claim 1 wherein the collagen cleaving agent is a metalloproteinase.

3. The method of removing hair as in claim 2 wherein the metalloproteinase is a collagenase

4. The method of removing hair as in claim 3 wherein the collagenase is present at concentration greater than about 0.001%

5. The method of removing hair as in claim 1 wherein the hair is allowed to fall out.

6. The method of removing hair as in claim 1 including the further step of inactivating the collagen cleaving agent after the collagen cleaving agent has been allowed to act.

7. The method of removing hair as in claim 3 wherein the collagenase is delivered without breaching the skin

8. The method of removing hair from a mammal as in claim 7 wherein the collagenase is at a concentration of between 0.05 and 30% w/w.

9. The method of removing hair as in claim 1 wherein the collagen cleavage agent is delivered by the application of heat

10. The method of removing hair as in claim 3 wherein the collagen cleavage agent is through a breach in the skin.

11. The method of removing hair as in claim 10 wherein the collagenase is present at concentration of between 0.001-0.1% w/w.

12. The method of removing hair as in claim 1 wherein the hair is positively removed from the area of skin.

13. The method of removing hair as in claim 1 where a divalent cation is delivered with the collagenase.

14. The method of removing hair from a mammal as in claim 7 wherein the mammal is human and the hair removal is for cosmetic purposes.

15. An animal husbandry method including the steps of delivering a metalloproteinase beneath the surface of an area of skin in an amount effective to depilate the area of skin.

16. The animal husbandry method as in claim 15 wherein the metalloproteinase is delivered through a puncture in the skin.

17. The animal husbandry method as in claim 16 wherein the metalloproteinase is delivered by injection.

18. The animal husbandry method as in claim 17 wherein the metalloproteinase is a collagenase.

19. The animal husbandry method as in claim 18 wherein the collagenase is at a concentration of between 0.001 and 0.1%.

20. The animal husbandry method as in claim 19 wherein the area of skin is the breech of a lamb.

21. The animal husbandry method as in claim 20 wherein the breech of the lamb remains hairless for at least four months.
